(19) United States
(12) Patent Application Publication
(10) Pub. No.: US 2022/0391674 A1
(43) Pub. Date: Dec. 8, 2022

(54) METHOD FOR OPTIMIZING EXECUTION TIME OF AN ARTIFICIAL NEURAL NETWORK

(71) Applicant: STMicroelectronics S.r.l., Agrate Brianza (MB) (IT)

(72) Inventor: Francesco Caserta, Napoli (IT)

(21) Appl. No.: 17/744,062

(22) Filed: May 13, 2022

(30) Foreign Application Priority Data
May 28, 2021 (FR) 2105613

(51) Int. Cl. G06N 3/04; G06N 3/08

(52) U.S. Cl. CPC G06N 3/0481; G06N 3/082

(57) ABSTRACT

According to one aspect, it is proposed a method for simplifying a trained artificial neural network, the method including: obtaining a trained neural network having layers of neurons, each layer being configured to receive at least one input, each input being connected to at least one neuron of the layer by a connection applying a weight, named trained weight, to the input, and for each input of each layer of the trained neural network: ∘ forming clusters of trained weights of the connections of the layer connected to said input of the layer, ∘ computing a representative weight for each cluster, the representative weight being representative of the weights of the cluster, ∘ replacing in the trained neural network the trained weights of each cluster by the representative weight of this cluster to obtain a simplified neural network.

### CROSS-REFERENCE TO RELATED APPLICATIONS

This application claims priority to French Application No. 2105613 filed on May 28, 2021, which application is hereby incorporated by reference herein in its entirety.

### TECHNICAL FIELD

The present disclosure generally relates to artificial neural networks, and in particular embodiments, to an optimization of the execution time of artificial neural networks.

### BACKGROUND

Artificial neural networks are used in industry, telecommunications, and entertainment, for example, in consumer electronics devices, to recognize images, sounds, gestures, and control of industrial processes.

Artificial neural networks generally include a succession of layers of neurons. The succession of layers includes an input layer configured to receive a set of data, at least one hidden layer, and an output layer configured to deliver a final result. Each layer includes at least one neuron. Each artificial neuron of a layer receives at least one input and produces a single output which can be sent to at least one neuron of the next layer. Thus, the inputs of each hidden layer are received from the previous layer of the neural network.

Each layer includes several neurons that can be determined at the design stage of the neural network, depending on the specific application. The output of a neuron depends on the type of neuron chosen at the design stage. For example, in the perceptron, weights are applied to all the previous layer's outputs to obtain weighted inputs. Then, a weighted sum is computed by summing each neuron's weighted input. A bias term can be added to the weighted sum. The result is then passed through a (usually nonlinear) activation function to produce the neuron's output.

In particular, in most common types of neurons, such as convolutional neurons, a sum of weighted inputs is computed.

The value of the weights and the bias are determined through a training phase of the neural network. In the training phase, known external input data are used, from which it is desired to obtain corresponding expected external output data.

Initial output data is computed using initial weights and an initial bias, starting from the known external input data. The initial weights and the initial bias are then modified to minimize a cost function given by the difference between the expected external output data and the initial output data.

Artificial neural networks typically include a very large number of neurons. Consequently, the execution time of an artificial neural network is high. Furthermore, the execution of the artificial neural network requires high computational resources, which are notably adapted to execute the neural network by using parallel computing.

Suppose the artificial neural network is performed by an electronic device, for example, in an embedded system including a microcontroller with limited computational resources. In that case, the execution time is long and unsuitable for specific applications. Indeed, embedded systems execute the neural network sequentially.

Solutions for reducing the execution time of an artificial neural network are known.

Most of these solutions involve a pruning algorithm. In a pruning algorithm, neurons of an already trained artificial neural network are ranked according to their importance. Less important neurons are removed from the artificial neural network to reduce the computational resources required to run the network. Then, the artificial neural network is generally retrained at the end of the pruning algorithm.

However, retraining a neural network is lengthy and costly in terms of computational resources. Consequently, it is desirable to train a neural network only once. Also, it may not be possible to retrain the neural network depending on the applications. Moreover, the neural network obtained after pruning may also be too complex for its execution by an integrated circuit.

Alternatively, it is possible to use an artificial neural network that is less complex, such as having fewer neurons and hidden layers. However, this also limits the neural network's ability to solve complex problems.

The problem, therefore, arises of providing a method for reducing the execution time of an artificial neural network, capable of overcoming the disadvantages of the prior art.

### SUMMARY

According to the disclosure, it is proposed a method for simplifying a trained artificial neural network, the method including obtaining a trained neural network having layers of neurons, each layer being configured to receive at least one input, each input being connected to at least one neuron of the layer by a connection applying a weight, named trained weight, to the input, and for each input of each layer of the trained neural network forming clusters of trained weights of the connections of the layer connected to said input of the layer, computing a representative weight for each cluster, the representative weight being representative of the weights of the cluster, replacing in the trained neural network the trained weights of each cluster by the representative weight of this cluster to obtain a simplified neural network.

It is also proposed a method for executing a simplified neural network obtained by the method above for simplifying a trained neural network, including, for each layer of the simplified neural network computing, for each input of the layer, weighted inputs by multiplying the input by the representative weights of the different connections connected to this input, and for each neuron of the layer: computing the sum of the weighted inputs and of bias connected to this neuron to obtain an accumulated value, computing output of the neuron by passing the accumulated value in an activation function of the neuron.

Thus, the method for simplifying a trained artificial neural network is implemented after a learning process of the artificial neural network. The learning process of the artificial neural network allows defining the trained weights of the different layers of the neural network.

This method allows modifying the trained artificial neural network so as to obtain a simplified neural network.

In the simplified neural network, the trained weights of the layers of the trained neural network are replaced by representative weights. Preferably, the representative weights are chosen to minimize an increase of a cost function of the artificial neural network.

In particular, some of the weights of the connections connected to the same input can have a very similar or even equal value.

The replacement of the trained weights can impact the cost function of the artificial neural network. More particularly, replacing some of the trained weights can have a greater impact on the cost function than replacing other trained weights. For this reason, preferably, the clusters are formed according to an objective function that considers gradients of the weights with respect to the cost function to choose the representative weights that minimize its increase.

Then, the trained weights are replaced with their associated representative weights, which allows simplifying the artificial neural network.

The execution of the neural networks is improved to exploit the simplification of the artificial neural network. In particular, the products are not computed neuron by neuron but input by input to reduce the number of products to be computed and thus reduce the execution time of the neural network.

Such methods do not require retraining of the neural network, as the representative weights are directly obtained from the trained weights.

The methods allow reducing the computational resources to execute the neural network. Consequently, the method can be used by an embedded system having limited computational resources without compromising its accuracy. The method can also be used concurrently with other reduction techniques, such as pruning.

When executing the simplified neural network, the sum of the weighted inputs connected to a neuron can be performed after having computed all the weighted inputs.

Nevertheless, the sum of the weighted inputs can be computed by accumulating the weighted inputs after each computation of a weighted input of this neuron. In this case, the method for executing the simplified neural network includes, for each layer of the simplified neural network for each neuron of the layer: initializing an accumulated value to a bias connected to this neuron for each input of the layer and for each representative weight associated to this input: computing the weighted input by multiplying the representative weight for the current input adding the weighted input to the accumulated value of all the neurons using the current representative weight, for each neuron of the layer: computing the output of the neuron by passing the accumulated value in an activation function of the neuron.

According to a particularly advantageous implementation, the method includes for each input of each layer of the trained neural network forming multiple different sets of clusters of trained weights of the connections of the layer connected to said input of the layer, computing a representative weight for each cluster of each set, the representative weight being representative of the weight of the cluster, selecting the set of clusters that allows obtaining a minimum cost function when replacing the trained weights by the representative weights, replacing in the trained neural network the trained weights of each cluster of the selected set by the representative weight of this cluster to obtain the simplified neural network. This allows obtaining the representative weights for which the accuracy of the simplified neural network is the closest to the accuracy of the initial trained neural network.

Advantageously, the set of clusters that allows obtaining a minimum cost function is selected by using the formula:

$$arg {min}_{{S}_{i}} {\sum }_{k = 1}^{K} {\sum }_{{w}_{i , j} ∈ {S}_{i , k}} \frac{{\partial }^{2} J}{{\partial }^{2} {w}_{i , j}} {‖ {w}_{i , j} - {\overline{w}}_{i , k} ‖}^{2} ,$$

where Si is a set of cluster associated to an input i of the neuron, S_{i,k} are the clusters of a set Si, K is the number of clusters S_{i,k} of each set Si, wi,j for j ∈{1,. . . ,L} are the trained weights of the layer applied to the input i, w̅_{i, k} is the representative weight for the trained weights of a cluster S_{i,k}, and ∂²J/∂²wi,j for j ∈{1, . . . ,L} are the partial gradients of the cost function with respect to the current weight wi,j.

Each set of clusters can be calculated by, for example, modifying a well know clustering algorithm (e.g., a k-means algorithm, by using the aforementioned cost function).

Preferably, the simplified neural network is executed by an embedded system. Nevertheless, it is also possible to execute the neural network by another computing system.

According to another aspect, it is proposed a computer program product including instructions which, when the program is executed by a computer, cause the computer to obtain a trained artificial neural network having layers of neurons, each layer being configured to receive at least one input, each input being connected to at least one neuron of the layer by a connection applying a weight, named trained weight, to the input, and, cause the computer to, for each input of each layer of the neural network: form clusters of trained weights of the connections of the layer connected to said input of the layer, compute a representative weight for each cluster, the representative weight being representative of the weights of the cluster, replace in the trained neural network the trained weights of each cluster by the representative weight of this cluster to obtain a simplified neural network.

According to another aspect, a computer program product for executing the aforementioned simplified artificial neural network, the computer program including instructions which, when the program is executed by a computer, cause the computer to, for each layer of the simplified neural network: compute, for each input of the layer, weighted inputs by multiplying the input by the representative weights of the different connections connected to this input, then and, cause the computer to, for each neuron of the layer: compute the sum of the weighted inputs and of a bias connected to this neuron to obtain an accumulated value, compute the output of the neuron by passing the accumulated value in an activation function of the neuron.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is a diagram of an embodiment artificial neural network;

FIG. 2 is a diagram of an embodiment hidden layer of a trained artificial neural network;

FIG. 3 is a flow chart of an embodiment method for simplifying a trained neural network;

FIG. 4 is a diagram of an embodiment of a simplified, trained artificial neural network;

FIG. 5 is a flow chart of an embodiment method for executing a simplified neural network; and

FIG. 6 is a schematic of an embodiment system.

### DETAILED DESCRIPTION OF ILLUSTRATIVE EMBODIMENTS

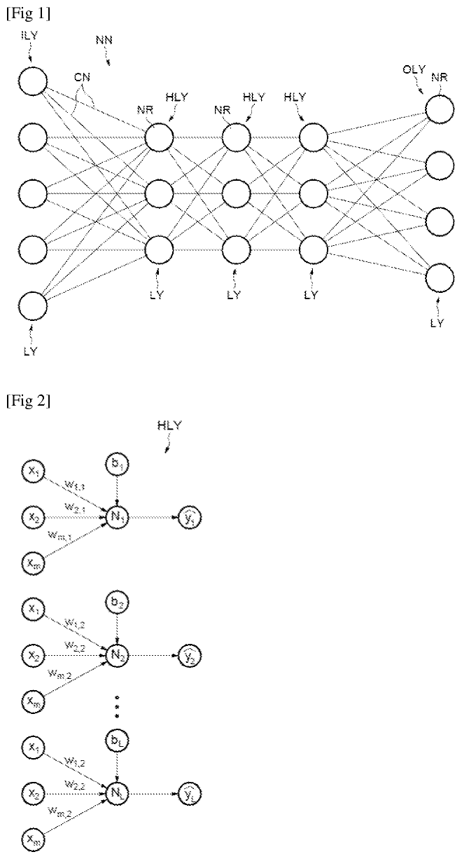

FIG. 1 shows an artificial neural network NN. The neural network NN includes a succession of layers LY of neurons NR. The succession of layers LY includes an input layer ILY configured to receive a set of data, at least one hidden layer HLY, and an output layer OLY configured to deliver a final result. Each layer LY includes at least one neuron NR. Each layer LY is configured to receive at least one input. Hidden layers HLY are configured to receive output(s) of the previous layer as input(s). Each input of a layer is connected to at least one neuron of the layer by a connection CN applying a weight to the input. The value of the weights is determined through a training phase of the neural network.

FIG. 2 shows an example of a given hidden layer HLY of a trained artificial neural network. In this example, the given hidden layer HLY has a number of neurons equal to L. Each neuron has a bias b₁ . . . b_{L}. Each neuron has a number m of input data xi (x₁, . . ., x,ₘ). For each input data xi, the neural network is trained to use L trained weights wi,1, . . . , wi,L, one for each neuron N1, . . . , NL. The weights wi,1, . . . , wi,L are determined through a training phase of the neural network. The neurons are configured to deliver respectively outputs ŷ₁, ŷ₂, . . . ŷ_{L}.

The trained weights wi,1, . . . , wi,L are generally different from each other. However, some of the weights of the connections connected to the same input can have a value very similar or even equal.

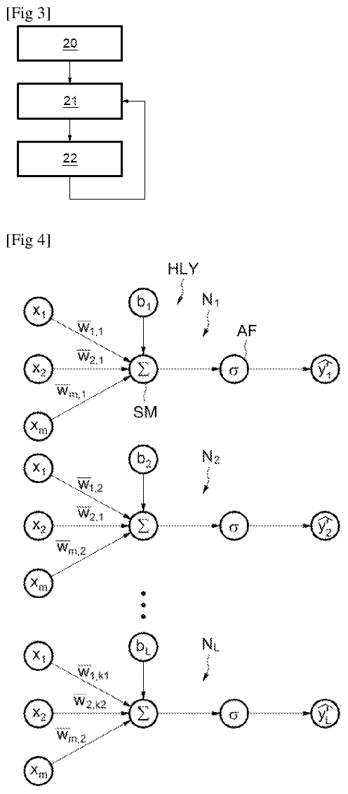

FIG. 3 shows a method for simplifying a trained neural network. The method includes steps 20 to 22 that are implemented by a computing system with, for example, high computational resources. In particular, the computing system includes a memory storing a computer program having instructions which, when the program is executed by a computer, cause the computer to implement the method for simplifying the trained neural network. Steps 20 to 22 allow obtaining a simplified neural network from a trained neural network.

FIG. 4 shows a given hidden layer HLY of such a simplified neural network that can be obtained from the layer shown in FIG. 2 of the trained neural network.

Referring back to FIG. 3, at step 20, the computing system obtains the trained neural network. Steps 21 to 22 are performed for each input of each layer of the neural network. In particular, at step 21, a clustering algorithm is executed on the trained weights wi,1, . . . , wi,L of the connections connected to the input xi. The trained weights are divided into a set Si of K clusters Si,1, . . . , S_{i,K} with K being smaller than L. Each cluster Si,1, . . . , Si,K includes at least one trained weight wi,1, . . . , wi,L, and is represented by a representative weight w̅_{i, 1}, . . . w̅_{i , K}. The cost function used in the clustering algorithm, for example, a modified k-means algorithm, can be:

$${\sum }_{k = 1}^{K} {\sum }_{{w}_{i , j} ∈ {S}_{i , k}} \frac{{\partial }^{2} J}{{\partial }^{2} {w}_{i , j}} {‖ {w}_{i , j} - {\overline{w}}_{i , k} ‖}^{2} ,$$

where S_{i,k} are the clusters of a set Si, K is the number of clusters S_{i,k} of the set Si, wi,j for j ∈{1, . . . L} are the trained weights of the layer applied to the input i, the clusters of a set including L trained weights in total (w_{i,1}, w_{i,2}, . . . , w_{i,L}), w̅_{i, k} is the representative weight for the trained weights of a cluster S_{i,k}, and ∂²J/∂²wi,j for j ∈{1, . . . ,L} are the partial gradients of the cost function with respect to the current weight wi,j.

It is important to minimize the difference between the output data of the modified neural network and the output data that would be obtained using the trained neural network and the external output data that would be obtained using the representative weights to maintain an acceptable cost function. This is achieved by including the gradients of the weights in the cost function. In fact, by multiplying the squared gradients for the squared difference of each trained weight and its representative weight, i.e.

$$\frac{{\partial }^{2} J}{{\partial }^{2} {w}_{i , j}} {‖ {w}_{i , j} - {\overline{w}}_{i , k} ‖}^{2} ,$$

the clustering algorithm obtains an estimation of the increase of the cost function obtained if w_{i,j} is replaced with w̅_{i, k}.

Once the optimal set of clusters minimizing the cost function is selected, the method includes step 22. At step 22, the trained weights of the layer applied to the given input are replaced by the representative weights associated with the clusters of the set. More particularly, the trained weights of the layer composing a cluster are replaced by the representative weight of this cluster. Thus, the trained weights composing the same cluster are replaced by the same representative weight in the neural network.

As indicated above, steps 21 to 22 are performed for each input of each layer. When all the neural network layers have been processed, a simplified neural network is obtained. In this simplified neural network, similar trained weights of connections connected to the same input of a layer are replaced by a representative weight. Thus, this method reduces the number of different weights of the trained neural network.

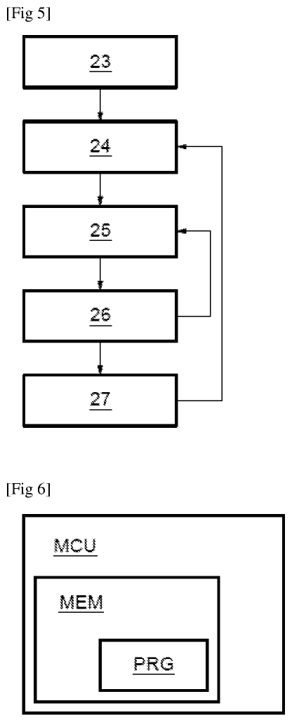

FIG. 5 shows a method for executing a simplified neural network obtained by the aforementioned method. The method includes steps 23 to 27 for executing the simplified neural network on a final computing system, such as an embedded system. The embedded system can include a microcontroller MCU to execute the simplified neural network, as shown in FIG. 6. The microcontroller can be any type of processor. In particular, the microcontroller MCU includes a memory MEM storing a computer program PRG having instructions which, when the program is executed by a computer, cause the computer to implement the method for executing the simplified neural network. The memory can be a non-transitory memory storage.

At step 23, the simplified neural network is provided to a final computing system. The final computing system can execute the neural network. The execution of each layer of the neural network follows a specific order. Steps 24 and 27 are performed for each layer of the simplified neural network. Steps 25 and 26 are performed for each different weighted input xᵢw̅_{i, k} of the layer, going input by input.

For the execution of a given layer, the final computing system starts by initializing, at step 24, an accumulated value a₁ . . . a_{L} of each neuron of the layer to the bias b₁ . . . b_{L} of the neuron.

At step 25, the current weighted input xᵢw̅_{i, k} for the current input xᵢ is computed by multiplying an input by a representative weight of a connection connected to this input.

For example, for a given input xi connected to neurons of the layer by the connections associated with weights w̅_{i, 1}, . . . w̅_{i, K}, the computing system computes the weighted inputs xᵢw̅_{i, 1}, . . . xᵢw̅_{i, K}, one by one in this step.

Then, at step 26, the computing system adds the current weighted input xᵢw̅_{i, k} to the accumulated value aₗ of the neurons N1 that received the weighted input xᵢw̅_{i, k}.

For example, the neurons Nx, Ny, and Nz might share the same weighted sum xᵢw̅_{i, k}. In this way, the value xᵢw̅_{i, k} is computed only one time and added to the three accumulated values aₓ, a_{y}, and a_{z}.

Then, at step 27, the activation function is computed on each neuron of the layer over the accumulated sums a₁ . . . a_{L} to obtain the outputs ŷ′₁ . . . ŷ′_{L}.

For example, to execute the neuron N1 in FIG. 4, the embedded system calculates the activation function of the neuron over the accumulated value a₁ to obtain the output ŷ′₂ of the neurons

In the same way, to execute the neuron N2, the embedded system computes the activation function of the neuron over the accumulated value a₂ to obtain the output ŷ′₂ of the neurons N2.

To execute the neuron NL, the embedded system computes the activation function of the neuron over the accumulated value a_{L} to obtain the output ŷ′_{L} of the neurons NL.

The method allows improving the execution of the neural networks. In particular, the products are not computed neuron by neuron but input by input so as to reduce the number of products to be computed and thus reduce the execution time of the neural network.

Such method does not require to retrain the neural network, as the representative weights are directly obtained from the trained weights.

The method allows reducing the computational resources to execute the neural network. Consequently, the method can be used by an embedded system having limited computational resources, without compromising accuracy.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A method for generating a simplified artificial neural network from a trained artificial neural network comprising layers of neurons, each layer having at least one input, and each input coupled to at least one neuron of the layer by a weight applied connection, the method comprising:
forming clusters of trained weights of the weight applied connection for each input of each layer of the trained artificial neural network;
computing a representative weight for each formed cluster; and
replacing the trained weights of the weight applied connection for each cluster with the representative weight to form the simplified artificial neural network.

2. The method of claim 1, further comprising:
forming sets of clusters of trained weights of the weight applied connection for each input of each layer of the trained artificial neural network;
computing a representative weight for each formed cluster of each set of clusters of trained weights;
selecting a subset of the set of clusters of trained weights such that a minimum cost function is achieved by replacing the trained weights of the weight applied connection by the representative weight; and
replacing the trained weights of the weight applied connection for each cluster of the selected subset with the representative weight to form the simplified artificial neural network.

3. The method of claim 2, wherein the subset of the clusters of trained weights is selected in accordance with the formula
$$arg {min}_{{S}_{i}} {\sum }_{k = 1}^{K} {\sum }_{{w}_{i , j} ∈ {S}_{i , k}} \frac{{\partial }^{2} J}{{\partial }^{2} {w}_{i , j}} {‖ {w}_{i , j} - {\overline{w}}_{i , k} ‖}^{2} ,$$
wherein Si are the sets of clusters, S_{i, k} are the subset of the set of clusters, K is the number of the subset of the set of clusters S_{i,k} of the sets of clusters Si, wi,j are the trained weights of the layer, the clusters of a set comprising L trained weights in total, w̅_{i, k} is the representative weight for the trained weights of the subset of the set of clusters S_{i,k}, and ∂²J/∂²wi,j for j ∈{1, . . . ,L} are the partial gradients of the cost function with respect to the trained weights wi,j of the layer.

4. The method of claim 1, further comprising:
computing weighted inputs for each input of the layer, the computing comprising multiplying the input by representative weights corresponding to connections connected to the input;
computing an accumulated value corresponding to the sum of the weighted inputs and bias connections of a neuron connected to the input; and
computing an output value of the neuron by passing the accumulated value in an activation function of the neuron.

5. The method of claim ₄, wherein the simplified artificial neural network is executed by an embedded system.

6. The method of claim 1, wherein the trained weights are determined through a training phase of the trained artificial neural network.

7. The method of claim 1, wherein the simplified artificial neural network includes less trained weights than the trained artificial neural network.

8. A non-transitory computer-readable media storing computer instructions for generating a simplified artificial neural network from a trained artificial neural network comprising layers of neurons, each layer having at least one input, and each input coupled to at least one neuron of the layer by a weight applied connection, that when executed by a processor, cause the processor to:
form clusters of trained weights of the weight applied connection for each input of each layer of the trained artificial neural network;
compute a representative weight for each formed cluster; and
replace the trained weights of the weight applied connection for each cluster with the representative weight to form the simplified artificial neural network.

9. The non-transitory computer-readable media of claim 8, wherein the computer instructions when executed by the processor, cause the processor to:
form sets of clusters of trained weights of the weight applied connection for each input of each layer of the trained artificial neural network;
compute a representative weight for each formed cluster of each set of clusters of trained weights;
select a subset of the set of clusters of trained weights such that a minimum cost function is achieved by replacing the trained weights of the weight applied connection by the representative weight; and
replace the trained weights of the weight applied connection for each cluster of the selected subset with the representative weight to form the simplified artificial neural network.

10. The non-transitory computer-readable media of claim ₉, wherein the subset of the clusters of trained weights is selected in accordance with the formula
$$arg {min}_{{S}_{i}} {\sum }_{k = 1}^{K} {\sum }_{{w}_{i , j} ∈ {S}_{i , k}} \frac{{\partial }^{2} J}{{\partial }^{2} {w}_{i , j}} {‖ {w}_{i , j} - {\overline{w}}_{i , k} ‖}^{2} ,$$
wherein Si are the sets of clusters, S_{i,k} are the subset of the set of clusters, K is the number of the subset of the set of clusters S_{i,k} of the sets of clusters Si, wi,j are the trained weights of the layer, the clusters of a set comprising L trained weights in total, w̅_{i, k} is the representative weight for the trained weights of the subset of the set of clusters S_{i,k}, and ∂²J/∂²wi,j for j ∈{1, . . . ,L} are the partial gradients of the cost function with respect to the trained weights wi,j of the layer.

11. The non-transitory computer-readable media of claim 8, wherein the computer instructions when executed by the processor, cause the processor to:
compute weighted inputs for each input of the layer, the computing comprising multiplying the input by representative weights corresponding to connections connected to the input;
compute an accumulated value corresponding to the sum of the weighted inputs and bias connections of a neuron connected to the input; and
compute an output value of the neuron by passing the accumulated value in an activation function of the neuron.

12. The non-transitory computer-readable media of claim 8, wherein the simplified artificial neural network is executed by an embedded system.

13. The non-transitory computer-readable media of claim 8, wherein the trained weights are determined through a training phase of the trained artificial neural network.

14. The non-transitory computer-readable media of claim 8, wherein the simplified artificial neural network includes less trained weights than the trained artificial neural network.

15. A device for generating a simplified artificial neural network from a trained artificial neural network comprising layers of neurons, each layer having at least one input, and each input coupled to at least one neuron of the layer by a weight applied connection, the device comprising:
a non-transitory memory storage comprising instructions; and
a processor in communication with the non-transitory memory storage, wherein the processor is configured to execute the instructions to:
form clusters of trained weights of the weight applied connection for each input of each layer of the trained artificial neural network,
compute a representative weight for each formed cluster, and
replace the trained weights of the weight applied connection for each cluster with the representative weight to form the simplified artificial neural network.

16. The device of claim 15, wherein the processor is configured to execute the instructions to:
form sets of clusters of trained weights of the weight applied connection for each input of each layer of the trained artificial neural network;
compute a representative weight for each formed cluster of each set of clusters of trained weights;
select a subset of the set of clusters of trained weights such that a minimum cost function is achieved by replacing the trained weights of the weight applied connection by the representative weight; and
replace the trained weights of the weight applied connection for each cluster of the selected subset with the representative weight to form the simplified artificial neural network.

17. The device of claim 16, wherein the subset of the clusters of trained weights is selected in accordance with the formula
$$arg {min}_{{S}_{i}} {\sum }_{k = 1}^{K} {\sum }_{{w}_{i , j} ∈ {S}_{i , k}} \frac{{\partial }^{2} J}{{\partial }^{2} {w}_{i , j}} {‖ {w}_{i , j} - {\overline{w}}_{i , k} ‖}^{2} ,$$
wherein Si are the sets of clusters, S_{i,k} are the subset of the set of clusters, K is the number of the subset of the set of clusters S_{i,k} of the sets of clusters Si, wi,j are the trained weights of the layer, the clusters of a set comprising L trained weights in total, w̅_{i, k} is the representative weight for the trained weights of the subset of the set of clusters S_{i,k}, and ∂²wi,j for j ∈{1, . . . ,L} are the partial gradients of the cost function with respect to the trained weights wi,j of the layer.

18. The device of claim 15, wherein the processor is configured to execute the instructions to:
compute weighted inputs for each input of the layer, the computing comprising multiplying the input by representative weights corresponding to connections connected to the input;
compute an accumulated value corresponding to the sum of the weighted inputs and bias connections of a neuron connected to the input; and
compute an output value of the neuron by passing the accumulated value in an activation function of the neuron.

19. The device of claim 15, wherein the trained weights are determined through a training phase of the trained artificial neural network.

20. The device of claim 15, wherein the simplified artificial neural network includes less trained weights than the trained artificial neural network.
